(19) United States
(12) Patent Application Publication
(10) Pub. No.: US 2015/0032588 A1
(43) Pub. Date: Jan. 29, 2015

(54) SYSTEMS AND METHODS FOR ENROLLING MERCHANTS USING CARD DATA

(71) Applicant: Robert Ryan SKOFF, II, San Francisco, CA (US)

(72) Inventor: Robert Ryan SKOFF, II, San Francisco, CA (US)

(73) Assignee: Capital One Financial Corporation, McLean, VA (US)

(21) Appl. No.: 14/336,476

(22) Filed: Jul. 21, 2014

Related U.S. Application Data
(60) Provisional application No. 61/857,843, filed on Jul. 24, 2013.

(51) Int. Cl. G06Q 20/34

(52) U.S. Cl. CPC G06Q 20/3567; G06Q 40/02
USPC 705/35

(57) ABSTRACT

The disclosed embodiments include methods, systems, and articles of manufacture for registering merchants to accept payments. A user interface is generated to include an option for a user to provide registration data from a card containing identification data. A ready signal is communicated to an input device indicating the user selected the option to provide the registration data from the card. Registration data is determined from a received data signal and a second user interface requesting confirmation of the registration data is generated. After the registration data is confirmed, the registration data is sent to a registration system.

### CROSS-REFERENCE TO RELATED APPLICATIONS

This application claims priority under 35 U.S.C. §119 to U.S. Provisional Patent Application No. 61/857,843, filed Jul. 24, 2013, which is incorporated herein by reference in its entirety.

### BACKGROUND

Financial service account products have become so universally well-known and ubiquitous that they have fundamentally changed the manner in which financial transactions and dealings are viewed and conducted in society today. For example, credit card products are most commonly represented by plastic card-like members that are offered and provided to customers through credit card issuers (such as banks and other financial institutions). With a credit card or similar financial service account product, an authorized customer or cardholder is capable of purchasing services and/or merchandise without an immediate, direct exchange of cash. With each purchase, the cardholder incurs debt which the cardholder can thereafter pay upon receipt of a monthly or otherwise periodic statement. In most cases, the cardholder will have the option to either fully pay the outstanding balance or, as a matter of necessity or choice, defer at least a portion or the balance for later payment with accompanying interest or finance charges for the period during which payment of the outstanding debt is deferred (also referred to as a revolving charge credit line).

Generally, merchants (e.g., businesses offering goods and/or services for sale) establish a merchant account to accept payments from consumers. A merchant account is a financial account that allows businesses to accept payments by payment cards, typically financial cards such as debit cards, credit cards, prepaid cards, loyalty cards, and/or gift cards. A merchant account is established under an agreement between a merchant and a merchant account provider (e.g., a financial institution such as bank) for the settlement of payment card transactions. In some cases, a payment processor, independent sales organization, or member service provider is also a party to the merchant agreement and associated payment transactions. Typically, merchant account providers provide merchants with a financial card (e.g., a debit card, credit card, or automated teller machine card) linked to the merchant account that enables the merchant to withdraw and deposit funds into the merchant account or make purchases using the merchant account. In some cases, merchants operate computerized point-of-sale (POS) terminals capable of reading financial cards (e.g., reading the financial cards' magnetic stripe, integrated circuit chip, etc.) and performing one or more operations to complete a payment transaction, consistent with the agreement.

Mobile computing devices have also become so universally well-known and ubiquitous that they have fundamentally changed the manner in which people communicate and conduct business. Mobile computing devices can include mobile phones, tablet computing devices, e-Readers, and personal digital assistants, for example. Mobile computing devices can provide a platform allowing merchants to accept payments from consumers without the need for a dedicated POS terminal. For example, the merchant account provider can provide merchants an application that performs the typical operations of a conventional POS terminal. Merchants can download and install the application on their mobile computing devices to accept payments, using the mobile computing device, from consumers using financial cards.

### SUMMARY

Disclosed embodiments include methods, systems, and articles of manufacture configured to, for example, register merchants to accept payments. In some embodiments, a system generates a user interface including an option for a user (e.g., a merchant) to provide registration data from a card containing identification data. The system receives a user selection indicating that the user selected the option to provide the registration data from the card. The system generates a ready signal indicating the user selected the option to provide the registration data from the card and communicates the ready signal to an input device. The system can then receive a data signal corresponding to the identification data from the card and determine the registration data based on it. The system can then generate a second user interface requesting confirmation of the registration data and, once confirmed, communicate the registration data to a registration system.

In certain aspects, the system's determination of registration data includes determining account information from the data signal. If the account information corresponds to a financial account, the system can request a portion of the registration data from an account system. In some embodiments, the data signal is an audio signal and the system decodes the audio signal when it determines the registration data from the data signal.

In some embodiments, the identification data on the card is stored as magnetically stored track data. According to some embodiments, the ready signal generated by the system includes instructions configured to cause the input device to read magnetic stripe data encoded according to the ISO/IEC 7813 standard. In some embodiments, the ready signal includes instructions configured to cause the input device to read magnetic stripe data encoded according to American Association of Motor Vehicle Administrators standards.

It is to be understood that both the foregoing general description and the following detailed description are exemplary and explanatory only and are not restrictive of the disclosed embodiments, as claimed.

The accompanying drawings, which are incorporated in and constitute a part of this specification, illustrate disclosed embodiments and, together with the description, serve to explain the disclosed embodiments.

### BRIEF DESCRIPTION OF THE DRAWINGS

FIG. 1 is a block diagram of an exemplary system, consistent with disclosed embodiments.

FIG. 2 is a block diagram of another exemplary system, consistent with disclosed embodiments.

FIG. 3 is a block diagram of another exemplary system, consistent with disclosed embodiments.

FIG. 4 is a block diagram of another exemplary system, consistent with disclosed embodiments.

FIG. 5 is a flowchart of a merchant registration process, consistent with disclosed embodiments.

FIG. 6 is exemplary user interface, consistent with disclosed embodiments.

FIG. 7 is another exemplary user interface, consistent with disclosed embodiments.

### DETAILED DESCRIPTION

Reference will now be made in detail to the disclosed embodiments, examples of which are illustrated in the accompanying drawings. Wherever convenient, the same reference numbers will be used throughout the drawings to refer to the same or like parts.

Currently, one way merchants can accept payments using a mobile computing device is by installing an application on the mobile computing device to accept payments from consumers using financial cards such as credit cards, debit cards, gift cards, or prepaid financial cards. As dedicated POS terminals typically contain hardware capable of reading information from financial cards that mobile computing devices lack (for example, magnetic stripe readers, Smart Card/integrated circuit chip readers, or RFID readers), alternative means of entering financial card information into the application for accepting payments are employed. For example, the application can provide a user interface where the merchant can manually type a credit card number into the application and also manually type the amount of the transaction for processing by the merchant account provider. While this solution is feasible and simple to implement, it can be difficult or cumbersome to use when compared with the ease of swiping a financial card using a dedicated POS terminal including a card reader.

In some cases, when a merchant account provider provides an application for merchants to accept payments using a mobile computing device, it also provides an input device configured with a card reader. Merchants can use the card reader to swipe financial cards similarly to how merchants can swipe financial cards using a dedicated POS terminal. For example, the merchant account provider can provide an input device including a magnetic stripe reader that interfaces with the mobile computing device. When a merchant wants to accept payment from a consumer using its mobile computing device, it can launch the application provided by the merchant account provider, swipe the consumer's financial card using the input device, and the input device can send the data encoded on the consumer's financial card to the application for further processing.

Currently, before accepting payments using an application executing on its mobile computing device, a merchant must apply for a merchant account with a merchant account provider and register the application and/or mobile computing device with the merchant account provider. The registration processes may be required, for example, to associate the merchant's merchant account with the application instance so that when merchants accept payments from consumers, the funds are deposited into the proper account (i.e., the merchant's merchant account). Current systems require merchants to register manually. For example, in current systems, a merchant must manually enter its banking information (e.g., account number, routing number, etc.) and identification information (e.g., business name, authorized card holder, address, etc.). Typically, registration is done through a user interface that is accessible through a web page provided by the merchant account provider, or through the merchant account provider's application for accepting consumer payments. For example, when a merchant downloads the application for accepting payments to its mobile computing device, the merchant can register the application by entering the required registration information using the input of the mobile computing device (e.g., keyboard, keypad, or virtual keyboard/keypad). Manual entry of registration information can be tedious and prone to error, especially when entering registration on a mobile computing device with a small keyboard or virtual keyboard.

Accordingly, disclosed embodiments describe systems and methods for using data associated with a merchant's financial card or government issued identification for registering the merchant to use a payment application of a merchant account provider. The disclosed embodiments provide merchants with the ability to enter registration data without manually entry. In some disclosed embodiments, merchants can use a card reader dongle, which is typically only used for accepting consumer payment transactions after registration, to swipe a financial card of the merchant to provide data that is needed for registration. In some disclosed embodiments, merchants can also swipe a government issued identification card to provide data that is needed for registration. The disclosed embodiments also describe a system and method where a photograph of the merchant's financial card or government issued identification card can be processed to obtain registration data. Also, in some disclosed embodiments, additional registration information can be obtained from a financial services provider associated with the merchant. The disclosed embodiments can provide a registration method that is quicker and less prone to error than currently employed registration methods.

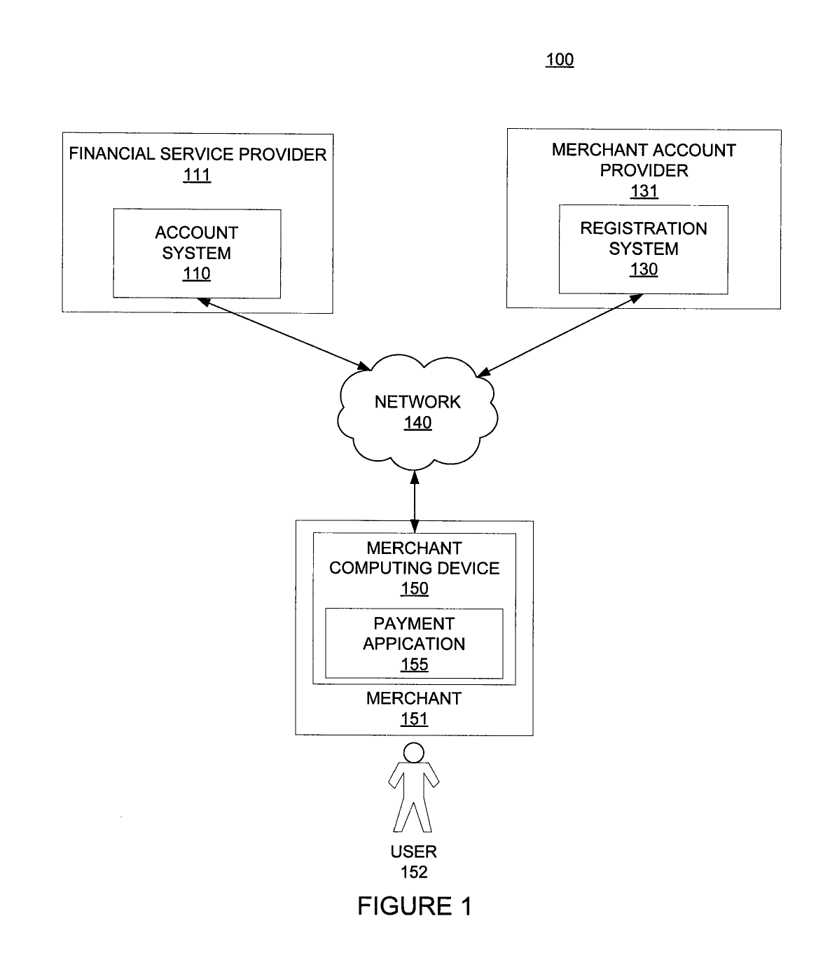

FIG. 1 is a block diagram of an exemplary system 100 for performing one or more operations consistent with the disclosed embodiments. In one embodiment, system 100 can include one or more account system(s) 110 operated by one or more financial services provider(s) 111, one or more registration system(s) 130 operated by one or more merchant account provider(s) 131, one or more merchant computing device(s) 150 operated by one or more merchant(s) 151, and a network 140. The components and arrangement of the components included in system 100 can vary. Thus, system 100 can include fewer or additional components that perform or assist in the performance of one or more processes consistent with the disclosed embodiments.

One or more components of system 100 can be computing systems configured to provide registration for merchants using card data. As further described herein, components of system 100 can include one or more computing devices (e.g., computer(s), server(s), etc.), memory storing data and/or software instructions (e.g., database(s), memory devices, etc.), and other known computing components. In some embodiments, the one or more computing devices are configured to execute software instructions stored on one or more memory devices to perform one or more operations consistent with the disclosed embodiments. Components of system 100 can be configured to communicate with one or more other components of system 100, including account system 110, registration system 130, and/or merchant computing device 150. In certain aspects, users (e.g., user 152) can operate one or more components of system 100 to initiate one or more operations consistent with the disclosed embodiments. In some aspects, the one or more users can be employees of, or associated with, the entity (e.g., financial services provider 111, merchant account provider 131, merchant 151) corresponding to the respective component(s) (e.g., someone authorized to use the underlying computing systems or otherwise act on behalf of the entity). In other aspects, the users may not be employees or otherwise associated with underlying entity. In still other aspects, the user can itself be the entity associated with the respective component. For example, merchant 151 can be a business entity (e.g., a store), or merchant 151 can be an individual (e.g., user 152).

Account system 110 can be a system associated with financial service provider 111. Financial service provider 111 can be a business entity that provides financial services to consumers, businesses, and other entities. For example, financial service provider 111 can be a bank, credit card issuer, credit bureau, credit agency, or other entity that generates, provides, manages, and/or maintains financial service accounts for one or more users. Account system 110 can generate, maintain, store, provide, and/or process financial data associated with one or more financial service accounts. Financial data can include financial service account data such as, for example, financial service account identification data, financial service account attribute data (e.g., account balance, available credit, existing fees, reward points, and user profile information), and/or financial service account transaction data (e.g., transaction dates, transaction amounts, transaction types, location of transaction, etc.). Account system 110 can include infrastructure and components that are configured to generate and/or provide financial service accounts such as credit card accounts (including private label/merchant credit card accounts), checking accounts, savings account, debit card accounts, loyalty or reward programs, lines of credit, and the like.

In some embodiments, financial services provider 111 can provide a credit account for use by businesses, such as merchants. Financial services provider 111 can provide a financial card, such as a credit or debit card to a merchant. The merchant card can then be used by the merchant to make purchases. For example, “John's Restaurant” opens an account with financial services provider 111 and deposits start-up funds in the account. Financial services provider 111 provides John's Restaurant with a financial card to make purchases on credit. When John's Restaurant needs supplies for the restaurant, it can use the financial card to make the purchases.

In some embodiments, account system 110 can provide account information to requesting computing systems, such as registration system 130, for example. Account system 110 can expose, in some embodiments, an application programming interface (API) that provides one or more methods for obtaining account information to requesting computing systems. For example, a requesting computing system can provide account system 110 with an account number via the API, and account system 110 can provide the requesting computing system with the name and address associated with the account number. The account information can be provided as a binary data stream, serialized data object, XML object, or in some other data form known to those with skill in the art.

In some embodiments, account system 110 can request, through the API, verification information from the requesting computing system. For example, account system 110 can request information from the requesting computing system concerning specific transactions on the account, or additional information concerning the account holder, before providing additional account details. For example, a requesting computing system may want the name and address associated with an underlying account number. The requesting computing system can send the account number, through the API of account system 110, to account system 110 and request the name and address. Before providing the name and address associated with the account, account system 110 can determine a previous transaction associated with the account. Account system 110 can also generate additional, fake transactions that are not associated with the account. The previous transaction and the fake transactions can then be sent to the requesting computing system in a verification transaction list along with a request to verify which of the transactions in the verification transaction list are associated with the account number sent by the requesting computing system. In some embodiments, after the requesting computing system provides the identity of the previous transaction (e.g., not one of the fake transactions), account system 110 can then provide the name and address associated with the account number.

Registration system 130 can be a computing system associated with a merchant account provider 131. Merchant account provider 131 can be an entity that offers merchant accounts allowing a business to accept payments from consumers using payment cards such as debit cards, credit cards, or prepaid cards (e.g., gift cards). A merchant account is established under an agreement between a merchant and a financial service provider (e.g., a bank) and the merchant account can be used for the settlement of payment card transactions. In some embodiments, merchant account provider 131 can also provide processing payment transactions, but merchant account provider 131 can also route payment transactions accepted by merchants to a third party payment processor according to some embodiments.

In some embodiments, merchant account provider 131 operates and controls registration system 130 for the purposes of registering merchants for new merchant accounts. For example, merchants can access registration system 130 using merchant computing device 150 to apply for a merchant account using an electronic registration interface (e.g., a registration web page). In some embodiments, merchant computing device 150 can access registration system 130 to register merchant 151 for services offered by merchant account provider 131 that are associated with the merchant's merchant account. For example, registration system 130 can provide a registration interface allowing merchants to register POS systems with merchant account provider 131 or for registering applications configured to accept payments from consumers.

Merchant computing device 150 can be one or more computing devices configured to perform one or more operations consistent with disclosed embodiments. Merchant computing device 150 can be a computing device that is controlled and operated by merchant 151. Merchant 151 can be a merchant that provides products (e.g., goods and/or services), such as a restaurant (e.g., Outback Steakhouse®, Burger King®, etc.), retailer (e.g., Amazon.com®, Target®, etc.), grocery store, service provider (e.g., utility company, insurance company, financial service provider, automobile repair services, etc.), non-profit organization (ACLU™, AARP®, etc.) or any other type of entity that provides goods, services, and/or information that consumers (i.e., end-users or other business entities) can purchase, consume, use, etc. For ease of discussion, the present disclosure may describe exemplary embodiments in the context of purchase transactions involving goods from retail merchants, but merchant computing device 150 is not limited to systems associated with retail merchants that conduct business in any particular industry or field.

In some embodiments, merchant 151 can have one or more user(s) 152 that are employees or agents of merchant 151 operating one or more merchant computing devices 150 that have been associated with the merchant's merchant account. User 152 may operate merchant computing device 150 under the authority of merchant 151 to handle one or more business tasks of merchant 151. For example, user 152 can use merchant computing device 150 to accept payments from consumers, register for merchant accounts, or register for services associated with merchant accounts, among other business tasks.

According to some embodiments, merchant computing device 150 can be a mobile device (e.g., tablet, smart phone, etc.), a desktop computer, a laptop, a server or any other type of computing device. Merchant computing device 150 can also include a television, e-reader, or any other type of device capable of communicating with other components of system 100.

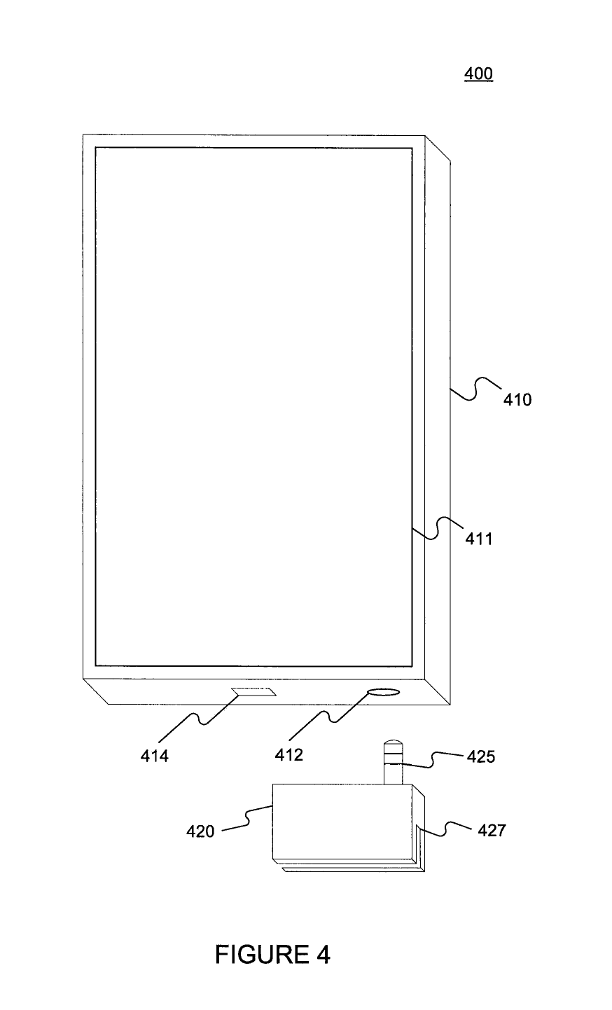

In some embodiments, registration system 130 provides merchant 151 with payment application 155 that can be used to accept financial card payments using a general computing device as opposed to a dedicated POS terminal. For example, registration system 130 can provide payment application 155, configured to be installed on a general purpose computing device, that interfaces with an input device connected to the general purpose computing system. The input device can be configured with a magnetic stripe reader allowing user 152 (on behalf of merchant 151) to swipe a payment card with a magnetic stripe to accept payment from a consumer using the consumer's payment card account. In some embodiments, the general purpose computing device is a mobile computing device and the input device is a magnetic stripe reader configured to interface with a standard port of the mobile computing device, such as an audio input/output port (e.g., a ⅛ inch phone connector). In some embodiments, payment application 155 can be configured to receive signals from the input, decode the signals to obtain consumer account information associated with a swiped payment card, and communicate the consumer account information to a payment processing computing system (not shown) associated with merchant account provider 131 for payment processing. Additional embodiments of using a mobile computing device to process payments from consumers is described below with respect to FIG. 4.

In some embodiments, merchants may need to register payment application 155 to associate it with their merchant account. For example, merchant 150 can download from registration system 130 payment application 155 to install on its mobile computing device (e.g., merchant computing device 150) for accepting payments from consumers. Before merchant 150 can accept payments from consumers, it may need to register the application with merchant account provider 131 so that merchant account provider 131 can correctly process payments accepted from consumers using payment application 155. According to some embodiments, merchant computing device 150 can access registration system 130 and provide the account information (e.g., account name, number, routing number, etc.) of merchant 151 to registration system 130. Registration system 130 can process the received account information to register the application. In some embodiments, registration system 130 provides a webpage or other system for merchant 150 to register payment application 155. In some embodiments, merchant 151 can register using one or more user interfaces of the application downloaded from registration system 130 to merchant computing device 150.

In some embodiments, merchant 150 can register payment application 155 using an input device (e.g., a magnetic stripe reader) connected to merchant computing device 150. According to some embodiments, merchant account provider 131 can provide one or more merchant account cards to the merchant. The merchant account card can be a financial card (e.g., debit card or credit card) allowing a merchant to access funds deposited in her merchant account. For example, merchant account provider 131 can provide a merchant account to “Sally Smith.” When Sally Smith applies for her merchant account (e.g., using registration system 130), merchant account provider 131 can provide Sally with a debit card that can be used to access funds deposited into her merchant account. Sally can use the debit card, for example, to make purchases for her business or for withdrawing cash from an Automated Teller Machine. According to some embodiments, the merchant account card can be used to register payment application 155 with registration system 130, as described in more detail below with respect to FIGS. 4-7.

Network 140 can be any type of network configured to provide communications between components of system 100. For example, network 140 can be any type of network (including infrastructure) that provides communications, exchanges information, and/or facilitates the exchange of information, such as the Internet, a Local Area Network, or other suitable connection(s) that enables the sending and receiving of information between the components of system 100. In other embodiments, one or more components of system 100 can communicate directly through dedicated communication link(s), such as links between account system 110, registration system 130, and merchant computing device 150.

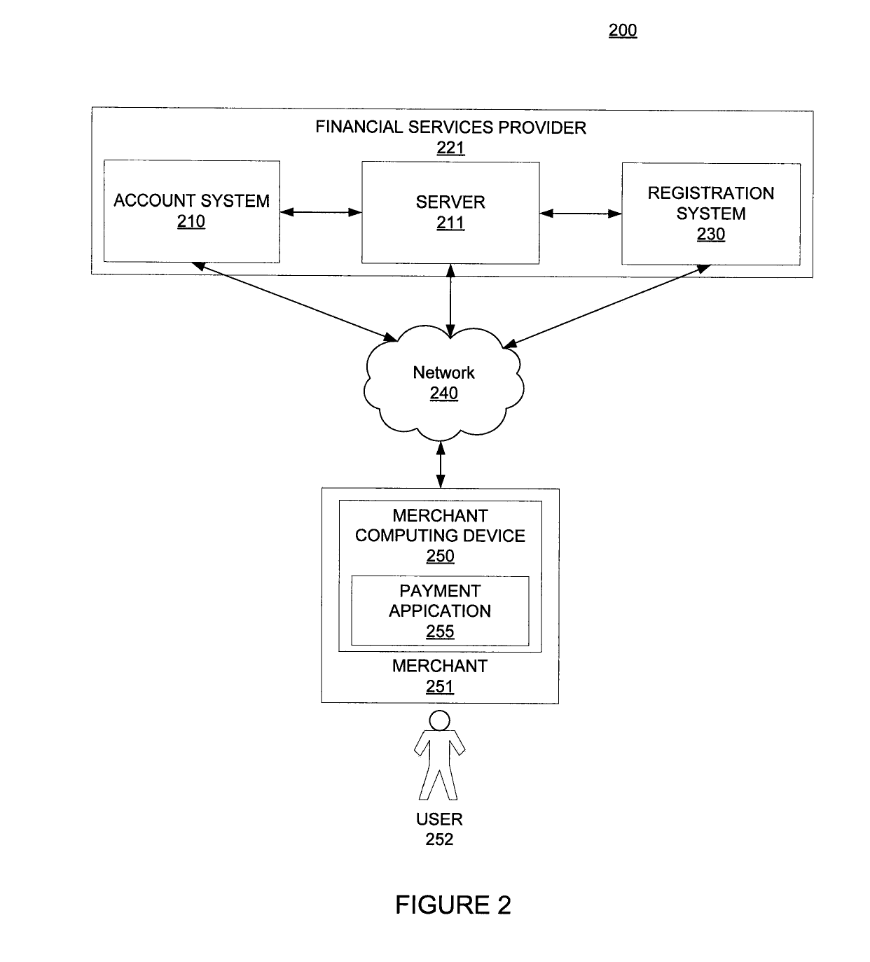

FIG. 2 is a block diagram of an exemplary system 200 that can perform one or more operations consistent with disclosed embodiments. In certain embodiments, financial service provider 221 can operate and control several computing systems such as account system 210, sever 211, and registration system 220, it can perform the roles of both financial services provider 110 and merchant account provider 131, as described above with respect to FIG. 1. Account system 210 can perform operations consistent with the operations of account system 110 described above with respect to FIG. 1, and registration system 230 can perform operations consistent with the operations of registration system 130 described above with respect to FIG. 1. Consistent with disclosed embodiments, account system 221 can use or otherwise directly communicate with computing devices of financial service provider system 221 (e.g., server 211). Furthermore, registration system 230 can directly access memory devices (not shown) and/or account system 221 of financial service provider system 221 to retrieve, for example, financial transaction data associated with merchant accounts for verification or account information to provide in response to requests from registration system 230. Merchant computing device 250 and payment application 255 can be configured and operate similar to similarly labeled components disclosed above in connection with FIG. 1.

It is to be understood that the configuration and boundaries of the functional building blocks of systems 100 and 200 have been arbitrarily defined herein for the convenience of description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. For example, registration systems 130, 230 can constitute a part of components of systems 100, 200 other than those specifically described or can constitute a part of multiple components of system 100 (e.g., a distributed system). Such alternatives fall within the scope and spirit of the disclosed embodiments.

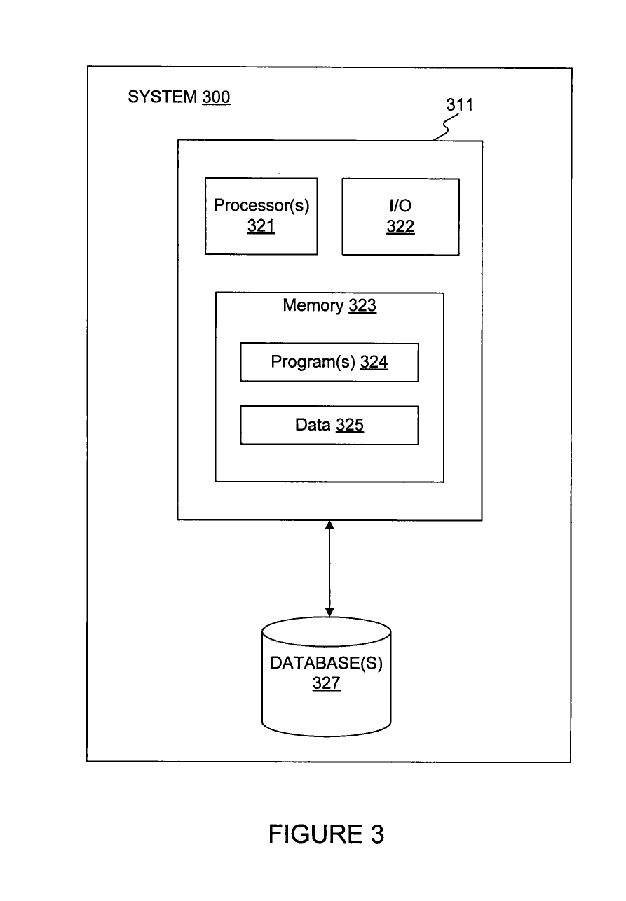

FIG. 3 shows an exemplary system 300 for implementing certain embodiments consistent with the present disclosure. For example, system 300 can represent components included with account system 110, registration system 130, and/or merchant computing device 150. For instance, registration system 130 can be configured with a computer system similar to system 300. Also, for example, merchant computing device 150 can be configured with a computer system similar to system 300.

In one embodiment, system 300 can include a computing device (shown as an example computing device 311) having one or more processors 321, one or more memories 323, and one or more input/output (I/O) devices 322. In some embodiments, computing device 311 can take the form of a mobile computing device, general purpose computer, a mainframe computer, or any combination of these components. Alternatively, computing device 311 (or a system including computing device 311) can be configured as a particular apparatus, embedded system, dedicated circuit, and the like based on the storage, execution, and/or implementation of the software instructions that perform one or more operations consistent with the disclosed embodiments. According to some embodiments, computing device 311 can comprise web server(s) or similar computing devices that generate, maintain, and provide web site(s) consistent with disclosed embodiments. Computing device 311 can be standalone, or it can be part of a subsystem, which can be part of a larger system. For example, computing device 311 can represent distributed servers that are remotely located and communicate over a network (e.g., network 140) or a dedicated network, such as a LAN. Computing device 311 can correspond to server 211, or separately to any server or computing device included in financial service provider 111, merchant account provider 131, and merchant 151.

Processor 321 can include one or more known processing devices, such as a microprocessor from the Pentium™ or Xeon™ family manufactured by Intel™, the Turion™ family manufactured by AMD™, or any of various processors manufactured by Sun Microsystems. The disclosed embodiments are not limited to any type of processor(s) configured in computing device 311.

Memory 323 can include one or more storage devices configured to store instructions used by processor 321 to perform one or more operations consistent with the disclosed embodiments. For example, memory 323 can be configured with one or more software instructions, such as program(s) 324 that can perform one or more operations when executed by processor 321. The instructions stored in memory 323 may define processor 321 to allow the system 300 to implement operations consistent with the present disclosure. The disclosed embodiments are not limited to separate programs or computers configured to perform dedicated tasks. For example, memory 323 can include a single program 324 that performs the functions of the computing device 311, or program 324 could comprise multiple programs. Additionally, processor 321 can execute one or more programs located remotely from computing device 311. For example, account system 110, registration system 130, and/or merchant computing device 150, can, via computing device 311, access one or more remote programs that, when executed, perform functions related to certain disclosed embodiments. Memory 323 can also store data 325 that can reflect any type of information in any format that the system can use to perform operations consistent with the disclosed embodiments. Although system 300 may be implemented as computer processing instructions, all or a portion of the functionality of system 300 may be implemented instead in electronics hardware.

I/O devices 322 can be one or more devices configured to allow data to be received and/or transmitted by computing device 311. I/O devices 322 can include one or more digital and/or analog communication devices that allow computing device 311 to communicate with other machines and devices, such as other components of systems 100 and 200.

Computing device 311 can also be communicatively connected to one or more database(s) 327. Computing device 311 can be communicatively connected to database(s) 327 through network 140. Database 327 can include one or more memory devices that store information and are accessed and/or managed through computing device 311. By way of example, database(s) 327 can include Oracle™ databases, Sybase™ databases, or other relational databases or non-relational databases, such as Hadoop sequence files, HBase, or Cassandra. The databases or other files can include, for example, data and information related to the source and destination of a network request, the data contained in the request, etc. Systems and methods of disclosed embodiments, however, are not limited to separate databases. In one aspect, system 300 can include database 327. Alternatively, database 327 can be located remotely from the system 300. Database 327 can include computing components (e.g., database management system, database server, etc.) configured to receive and process requests for data stored in memory devices of database(s) 327 and to provide data from database 327.

FIG. 4 shows and exemplary system 400 consistent with disclosed embodiments. System 400 can include merchant computing device 410 and card reader dongle 420, and system 400 can be used by merchants to accept payments from consumers. Merchant computing device 410 can be a mobile computing device and include input/output touchscreen display 411, phone connector 412, and data port 414. Input/output touchscreen 411 can be a resistive or capacitive touchscreen configured to display user interfaces and detect user selections when touched. Although not shown in FIG. 4, merchant computing device 410 can include a keypad that can be configured to detect user selections and input in some embodiments. Phone connector 412 can be a known connector used to accept audio signals and transmit them to the processor of merchant computing device 410 for additional processing. Phone connector 412 can be a TRS connector type (tip-ring-sleeve), TS connector type (tip-sleeve), or TRRS connector type (tip-ring-ring-sleeve). Data port 414 can be any known port that can accept a data signal, such as a USB port, Lightening® port, or other data port typical of mobile computing devices.

In some embodiments, merchant computing device 410 connects with card reader dongle 420. According to some embodiments, card reader dongle 420 can be configured to include one or more integrated circuits capable of performing operations consistent with disclosed embodiments. For example, card reader dongle 420 can include a processor, memory, and input/output devices similar to those described with respect to FIG. 3. Card reader dongle 420 can be configured to read financial cards using input slot 427. For example, card reader dongle 420 can include a magnetic stripe reader configured to read identification data stored on the magnetic track of financial cards or government issued identification cards according to the ISO/IEC 7813 standard (for financial cards) or the standards of the American Association of Motor Vehicle Administrators (AAMVA) (for government issued identification cards). According to some embodiments, card reader dongle 420 can include a reader configured to read an integrated circuit card, smart card, or chip card, or card reader dongle 420 can be configured to read cards configured with RFID tags, in some embodiments.

In some embodiments, card reader dongle 420 and merchant computing device 410 can be connected via phone connector 412. Connector 425 of card reader dongle 420 can be inserted into phone connector 412 of merchant computing device 410, thereby allowing card reader dongle 420 and merchant computing device 410 to send and receive data to each other. In some embodiments, card reader dongle 420 and merchant computing device 410 can be connected via data port 414, and connector 425 can be inserted into data port 414 thereby allowing card reader dongle 420 and merchant computing system 410 to send and receive data to each other. In some embodiments, card reader dongle 420 and merchant computing device can send data to each other via a wireless connection, such as Bluetooth®, for example.

In some embodiments, card reader dongle 420 can also be configured to transmit a signal containing identification data read from a card through connector 425 to merchant computing device 410 when card reader dongle 420 and merchant computing device 410 are connected. In embodiments where card reader dongle 420 and merchant computing device 410 are connected via phone connector 412, card reader dongle 420 can be configured to transmit a signal containing an encoded audio signal and merchant computing device 410 can be configured to decode the audio signal to determine the identification data stored on a card read by card reader dongle 420. For example, a merchant can use system 400 to accept payments from consumers using financial cards. When accepting payment, the merchant can swipe the consumer's financial card by moving it through input slot 427. The magnetic stripe reader of card reader dongle 420 can read the information stored on the magnetic stripe of the consumer's financial card, after which the data stored on the magnetic stripe can be run through a decoder and transformed into bits. Card reader dongle 420 can then encrypt the transformed bits into an encrypted set of bits, and card reader dongle 420 converts the encrypted set of bits into an audio signal (e.g., a .wav file, analog audio signal, .mp3 file, or other audio signal). Card reader dongle 420 then sends the audio signal through connector 425 to merchant computing device 410. Once merchant computing device 410 receives the audio signal, it decodes the audio signal using an application (e.g., payment application 155) and extracts the card's information from the audio signal.

In some embodiments, card reader dongle 420 can be commanded by merchant computing device 410 to read track data from the magnetic stripe of cards. Financial cards and government issued identification cards (collective “card(s)”) can have magnetic stripes that contains data associated with persons to which the cards belong. For many financial cards, magnetic stripes are encoded using the International Standards Organization and International Electrotechnical Commission 7813 standard (“ISO/IEC 7813 standard”). According to the ISO/IEC 7813 standard, magnetic stripes can contain up to three tracks which are generally known as tracks 1, 2, and 3. Although the ISO/IEC 7813 standard specifies three tracks, many magnetic stripes on financial cards typically contain data on tracks 1 and 2. Further, tracks 1 and 2 contain redundant data and some magnetic stripe readers can only read either track 1 or track 2. According to the ISO/IEC 7813 standard, the minimum cardholder account information needed to complete a transaction is present on tracks 1 and 2. Track 1 has a higher bit density than tracks 2 and 3 and is the only track that can contain alphabetic text, according to the ISO/IEC 7813 standard. As a result, track 1 is the only track that contains the cardholder's name.

According to the ISO/IEC 7813, the information on track 1 on financial cards is contained in several formats, one of which, B, is standard for card issuers (the other formats A, C-Z are reserved for other uses). Track 1, Format B contains the following information:

1. Start sentinel: one character indicating the start of data and is generally set to “%.”

2. Format code: one character indicating the format of data to follow. For B format, the format code is set to “B.”

3. Primary account number (PAN): one to nineteen characters representing the account number associated with the financial card. In some embodiments, the PAN matches the account number printed on the front of the financial card.

4. Field Separator: one character used to separate the PAN data field from the next data field. Generally set to “̂.”

5. Name: two to twenty-six characters corresponding to the name associated with the financial card.

6. Field Separator: one character used to separate the Name data field from the next data field. Generally set to “̂.”

7. Expiration date: four characters representing the expiration data for the financial card in the form YYMM.

8. Service code: three characters representing the service code associated with the financial card. Service codes can indicate how and when the financial card can be used. For example, service codes can convey information about international interchanges, whether an issuer should be contacted when the card is used, and whether the financial card is a debit card, credit card, or automated teller machine card.

9. Discretionary data: can include, for example, a Pin Verification Key Indicator (PVKI, 1 character), a PIN Verification Value (PVV, 4 characters), a Card Verification Value or Card Verification Code (CVV or CVC, 3 characters)

10. End sentinel: one character indicating the end of the track data on the card, which is generally set to “?.”

11. Longitudinal redundancy check (LRC): one character and a validity character calculated from other data on the track that can be used by reader devices, such as card reader dongle 420, to verify that the data read from the card is valid.

ISO/IEC 7813 Track 2, format B is written with a 5-bit scheme (four data bits and one parity), allowing for sixteen possible characters including the numbers 0-9, plus the six characters “:”, “;”, “<”, “=”, “>”, and “?” (which map to ASCII range 0x30 through 0x3f which defines the ten digit characters plus the six symbols). The data format for Track 2 is as follows (descriptions are the same as for Track 1): start sentinel, PAN, separator, expiration date, service code, discretionary data, end sentinel, and LRC.

Government issued identification cards, such as driver's licenses, can also contain data encoded on a magnetic stripe. The data stored on magnetic stripes on American driver's licenses is specified by the American Association of Motor Vehicle Administrators (the “AAMVA standard”). The AAMVA standard specifies data for all three tracks. The following data is stored on Track 1:

1. Start sentinel: one character indicating the start of data, which is generally set to “%.”

2. State or Province: two characters representing the identification holder's state

3. City: up to thirteen characters representing the identification holder's city.

4. Field Separator: one character to separate data fields, which is generally “̂.” The field separator can be absent if the city data field reaches its maximum length.
5. Last Name: variable length of characters representing the identification holder's last name.

6. Field Separator: one character to separate data fields, which is generally “$.”

7. First Name: variable length of characters representing the identification holder's first name.

8. Field Separator: one character to separate data fields, which is generally “$.”

9. Middle Name: variable length of characters representing the identification holder's middle name.

10. Field Separator: one character to separate data fields, which is generally “̂.”

11. Home Address: variable length of characters representing the identification holder's home address street number and street name.

12. Field Separator: one character to separate data fields, which is generally “̂.”

13. Reserved Data Field: an unspecified data field of variable length that can be reserved for future use or contain customizable data.

14. End Sentinel: one character denoting the end of track 1 data, and is generally “?”.

The following data is stored on Track 2:

1. Issuer Identifier Number (IIN): six digits representing the identification of the issuer for the identification card.

2. Driver's License/Identification Number: thirteen digits representing the driver's license or identification number associated with the identification card.

3. Field Separator: one character to separate data fields, which is generally “=.”

4. Expiration Date: four digits in YYMM format.

5. Birth date: eight digits in YYYYMMDD format.

6. Driver's License/Identification Number overflow: up to five digits that can be used in jurisdictions that use driver's license or identification numbers longer than 13 digits.

7. End Sentinel: one character denoting the end of track 2 data, which is generally “?”.

According to the AAMVA standard, Track 3 data can include the following information and the format (e.g., the number of characters for each data field) can vary from jurisdiction to jurisdiction: Postal Code, Driver's License Class, Restrictions, Endorsements, Gender, Height, Weight, Hair Color, and/or Eye Color.

In some embodiments, card reader dongle 420 can read magnetic stripes encoded according to the ISO/IEC 7813 and/or the AAMVA standard. In some embodiments, card reader dongle 420 can read the magnetic stripe of the card and apply decision logic to the data to determine the standard by which the magnetic stripe has been encoded. For example, card reader dongle 420 can attempt to decode the data on the magnetic stripe using the ISO/IEC 7813 standard, and if unsuccessful, can then attempt to read the information using the AAMVA standard. In some embodiments, the card reader dongle 420 can apply a character mask (e.g., using a regular expression) to the data to identify the magnetic stripe's standard. According to some embodiments, card reader dongle 420 can receive a signal instructing it as to the standard. For example, merchant computing device 410 can display a user interface asking the user if they are going to swipe a financial card or a driver's license, and merchant computing device 410 can send a signal to card reader dongle 420 representing the user's choice.

Although, in some embodiments, card reader dongle 420 can be configured to read magnetic stripes encoded according to the ISO/IEC 7813 and/or the AAMVA standards, those with skill in the art can contemplate other data formatting schemes that can be employed to encode data on cards, and the spirit and scope of the disclosed embodiments is not limited by the standard by which data is encoded on cards. Also, while the description above with respect to FIG. 4 describes card reader dongle 420 as performing certain operations, those with skill in the art will understand that some or all of those operations can be performed by an application executed by merchant computing device 410 (e.g., payment application 155) without deviating from the spirit and scope of the disclosed embodiments.

In some embodiments, system 400 can register merchant accounts for accepting payments from consumers using financial cards. For example, after a merchant downloads a payment application to merchant computing device 410, the merchant (or a user authorized to act on behalf of the merchant), can swipe a financial card or government issued identification card using card reader dongle 420, and the information stored on the financial or government issued identification card's magnetic stripe can be used to register the payment application with a registration system (e.g., registration system 130) of a merchant account provider (e.g., merchant account provider 131).

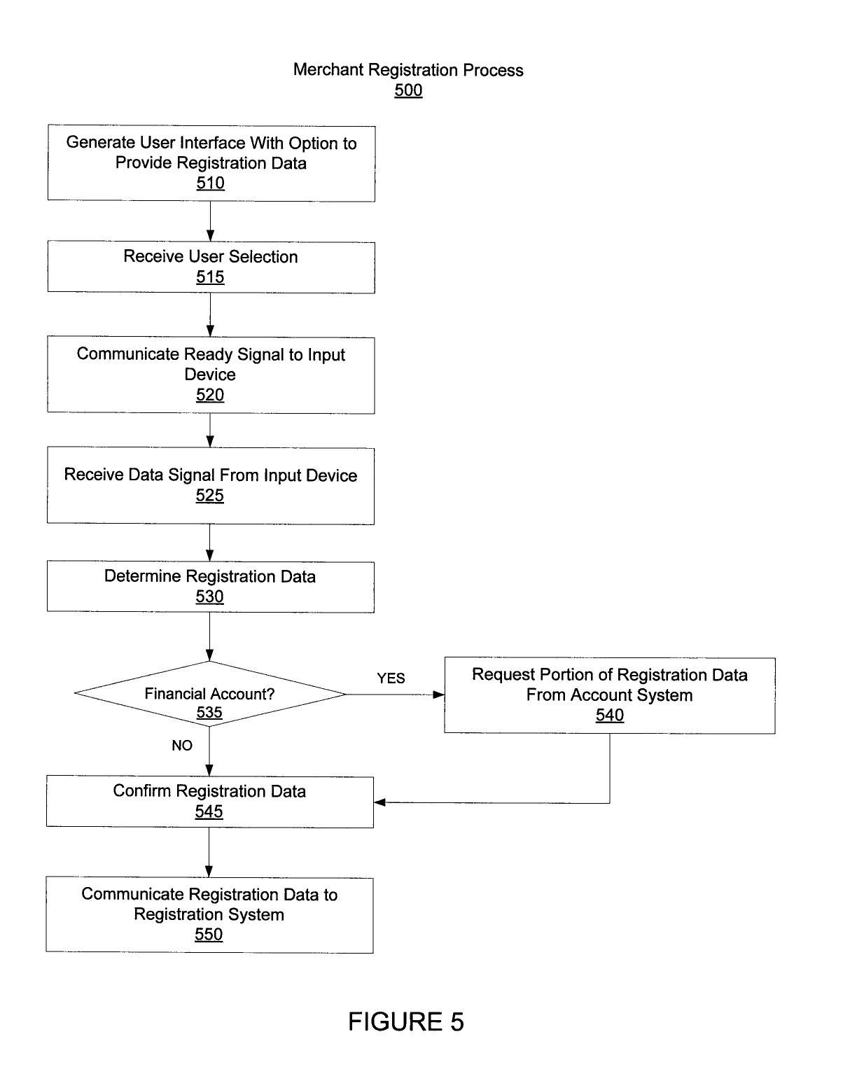

FIG. 5 shows a flowchart of an exemplary merchant registration process 500 consistent with disclosed embodiments. According to some embodiments, one or more sub-processes of process 500 can be performed by merchant computing device 150, 250, 410 by executing software instructions stored in one or more memory devices. In some embodiments, the software instructions can include instructions embodied as payment application 155, 255. Merchant registration process 500 can be executed by a merchant computing device to provide registration data to a registration system (e.g., registration system 130, 230), associated with a merchant account provider (e.g., merchant account provider 131) or a financial services provider (e.g. financial services provider 111, 211).

According to some embodiments, a merchant computing device can begin executing merchant registration process 500 by generating a user interface with an option to provide registration data (step 510). Merchants can provide registration information in a variety of ways depending on the embodiment. For example, merchants can manually enter registration information or merchants can swipe a financial or government issued identification card including data on a magnetic stripe. In some embodiments, the merchant computing device can accept an image of a financial card or government issued identification card and use known OCR techniques to determine information on the face of the cards that could be used for registration purposes. As the merchant computing device can accept multiple methods of input, it may request from the user the method the user would prefer. In some embodiments, this can be done using a user interface

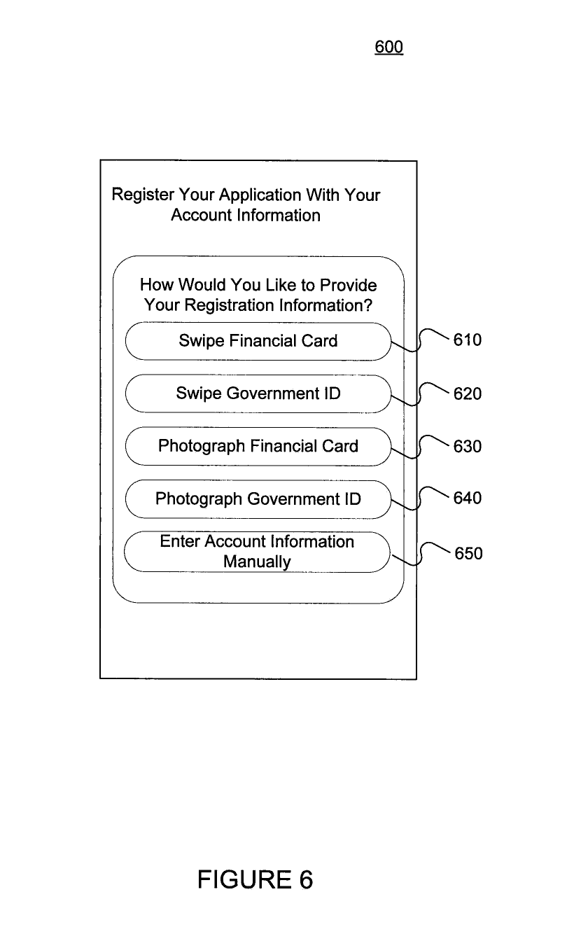

FIG. 6 illustrates an exemplary user interface 600 that can be generated by a merchant computing device while executing merchant registration process 500 (e.g., at step 510). User interface 600 includes selection buttons 610, 620, 630, 640, and 650. Each of selection buttons 610, 620, 630, 640, and 650 correspond to a method of inputting registration information to the merchant computing device. In some embodiments, the merchant computing device receives a user selection that the merchant would like to swipe a financial card to enter registration data (at step 515 of FIG. 5) by detecting an event that swipe financial card button 610 was selected by the user (e.g., by detecting a tap or click event on the button). The merchant computing device can receive a user selection that the merchant would like to swipe a government identification card to enter registration data (at step 515 of FIG. 5) by detecting an event that swipe government id button 620 was selected by the user (e.g., by detecting a tap or click event on the button). Also, the merchant computing device can receive a user selection that the merchant would like to photograph a financial card or government identification card to enter registration data (step 515 of FIG. 5) by detecting an event that photograph financial card button 630 or photograph government ID button 640, respectively, was selected by the user. The merchant computing device can receive a user selection that the merchant would like to manually enter registration data (step 515 of FIG. 5) by detecting an event that selection button 650 was selected by the user.

Returning to FIG. 5, the merchant computing device can further perform merchant registration process 500 by communicating a ready signal to the appropriate input device (step 520). According to some embodiments, the input device can be a card reader (e.g. card reader dongle 420), or the input device can be a camera. The input device can be a peripheral device (e.g. a card reader dongle or POS system) or an internal device (e.g., built in camera, touchscreen keyboard, or a set of button or keys). In some embodiments, the ready signal includes data notifying the input device that it is about to receive input. For example, after the merchant computing system receives a user selection that the user will swipe a financial card, merchant computing system can generate and communicate a ready signal to a card reader input device (e.g., card reader dongle 420) to notify it that the user is about to swipe her financial card. In some embodiments, the ready signal can contain additional information for the input device concerning the user's input. For example, the ready signal can contain information informing a card reader device that the user will swipe a financial card (e.g., the card has a magnetic stripe coded to the ISO/IEC 7813 standard) or a government issued identification card (e.g., the card has a magnetic stripe coded to the AAMVA standard). According to some embodiments, the ready signal can communicate the type of input that user will provide to the input device. For example, the ready signal can contain data that informs the input device that the user will swipe a card with a magnetic stripe or it can inform the input device that the user will swipe an integrated circuit chip card or RFID card.

The merchant computing system further performs the operations of merchant registration process 500 by receiving a data signal from the input device (step 525). According to some embodiments, the data signal contains the identification information from the user's financial or government issued identification card. The data signal can contain, for example, a set of data bits corresponding to registration information and the merchant computing system can parse the data bits to determine registration data (step 530). In some embodiments, the data signal contains an audio signal generated by the input device (e.g., card reader dongle 420) that can be decoded by the merchant computing system to determine registration data (step 530). In some embodiments, the data signal contains an image of a user's financial or government issued identification card that can be processed (e.g., using OCR technology) to extract and determine registration information (step 530). In some embodiments, the input signal can include data representing a serialized object that can be deserialized by the merchant computing system and from which registration data can be obtained (step 530).

In some embodiments, the merchant computing system can determine if the determined registration data is associated with a known financial account (step 535), and obtain additional registration data from an account system associated with the financial account (e.g., account system 110, 210). For example, after the merchant computing system receives the data signal, it can determine that the signal contains registration data for John Smith with account number 12345678, but the data signal may not contain additional registration data such as John Smith's address. In some embodiments, the merchant account system can recognize the format of the account number as an account number of John Smith's financial services provider, Big Bank. The merchant account system can, for example, contain a look-up table that compares the format of the account number to formats of common financial services providers, or, in some embodiments, the merchant account system can query several account systems of financial services providers attempting to find the financial services provider associated with the account. If the registration data is associated with a known financial account (step 535: YES), the merchant computing device can request a portion of the registration data from the account system (step 540). For example, the merchant computing device can request the John Smith's address from Big Bank's account system.

In some embodiments, as described above with respect to FIG. 1, account systems may not provide data concerning accounts without first verifying that the requesting system has the authority of the account holder to provide the information. In such embodiments, account systems can request verification information from the requesting system. Accordingly, in some embodiments, the merchant computing device can generate one or more user interfaces asking the user for the verification information requested of it. For example, suppose John Smith has a mortgage payment of $1000 a month payable to Mighty Mortgage. When the merchant computing device requests a portion of registration data from Big Bank's account system (e.g., at step 540), Big Bank's account system can request that the merchant computing device verify John Smith's mortgage payment to Mighty Mortgage. The merchant computing device can also generate and display a user interface requesting that John Smith enter his monthly payment amount for Mighty Mortgage. Once merchant computing device receives a response, merchant computing device can send it to Big Bank's account system, which can then verify the response and provide the additional requested registration information.

If the merchant computing device does not determine that a financial account is associated with the determined registration data (step 535: NO), or after the requested portion of registration data from account system has been received from the account system (step 540), the merchant computing device may confirm with the user the registration data it determined (step 545). In some embodiments, merchant computing device can request confirmation by generating a user interface containing the registration data and providing an option for the user to confirm the registration data or edit the registration data, if needed.

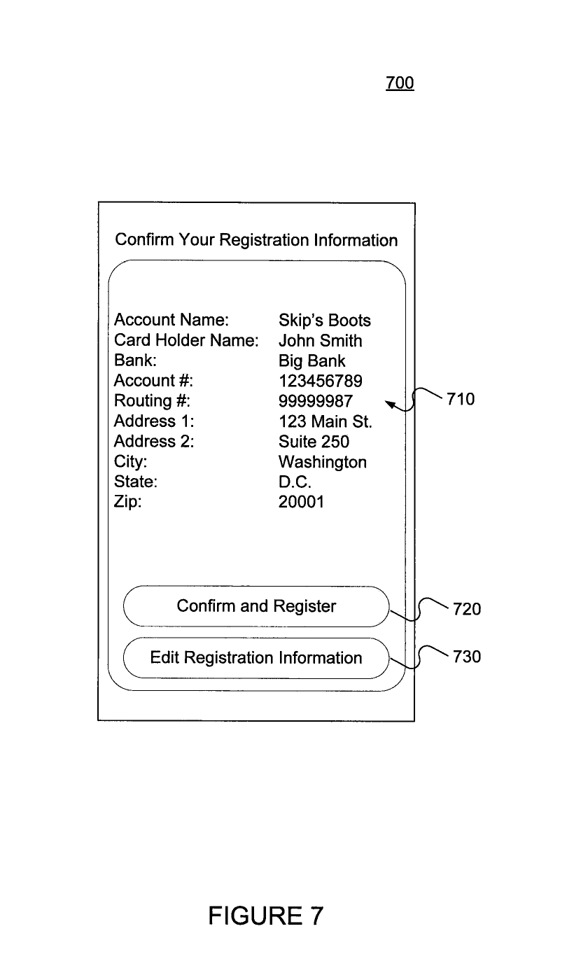

FIG. 7 illustrates an exemplary user interface 700 that can be generated by a merchant computing device while executing merchant registration process 500 (e.g., at step 545) to confirm registration data. According to some embodiments, user interface 700 can include registration information box 710, confirm and register button 720 and edit registration button 730. The merchant computing device can generate and display the registration information box 710 to communicate to the user the registration data is has determined. In some embodiments, registration information box 710 can be incomplete and missing data for one or more data fields (e.g., address), in which case merchant computing device may not generate user interface 700 to include confirm and register button 720. When the merchant computing device detects a tap or click event on the confirm and register button, it will send the registration information to a registration system of a merchant account provider. When the merchant computing device detects a tap or click event on the edit registration information button 730, it can display a virtual keyboard or some other virtual input device, or accept input from a keyboard or other input device, that provides the user the opportunity to edit any of the registration information displayed in registration information box 710.

Merchant computing device can also communicate the registration data to a registration system of a merchant account provider (step 550). The merchant computing device can communicate the registration data to the registration system consistent with the embodiments described above with respect to FIG. 1, or using methods of communicating data between systems known by those with skill in the art.

The described embodiments provide systems and methods for registering merchants using card data, i.e., merchants can register a payment application by swiping a financial or government issued card using a card reader connected to a computing device. In operation, the system and method provides merchants the ability to register payment applications entering minimal information quickly and with little error. Merchant registration using described embodiments can be illustrated in a non-limiting example for explanatory purposes only:

A merchant enrolls for a merchant account with a merchant account provider and also enrolls for a bank account with a financial services provider. The merchant's bank provides the merchant with a bank card associated with his bank account. The merchant account provider offers a payment application that can be downloaded to the merchant's mobile computing device to accept payments from consumers using the mobile computing device. As the merchant is interested in accepting payments from consumers using financial cards, the merchant downloads the payment application. The merchant account provider also offers an input device in the form of a card reader dongle for swiping financial cards. Using the card reader dongle, the merchant need not manually enter the account numbers of financial cards to accept payment from consumers. Rather, the merchant can swipe the financial card, and the card reader dongle and payment application can read the information stored on the financial card and process payment.

But before the merchant can begin accepting payments, the merchant will need to register its payment application with the merchant account provider. The first time the merchant launches the payment application on its computing device, the computing device can display a user interface asking if the merchant would like to manually enter registration data, or if the merchant would like to swipe or photograph a financial or government issued identification card to begin the registration process. The merchant chooses to swipe a financial card, and swipes the bank card given to it by the financial services provider using the card reader dongle connected to its computing device. The dongle sends a signal containing the information stored on the magnetic stripe of the bank card to the computing device which extracts registration information from the signal. The computing device requests verification of the extracted registration information. Once verified, the computing device communicates the registration information to the merchant account provider's registration system to register the payment application with the merchant account provider. The merchant's payment application is now registered with the merchant account provider, and the merchant can being accepting payments from consumers.

The above examples are non-limiting and are provided for explanatory purposes only. Other embodiments will be apparent to those skilled in the art from consideration of the specification and practice of the disclosed embodiments. It is intended that the specification and examples be considered as exemplary only, with a true scope and spirit of the disclosed embodiments being indicated by the following claims. Furthermore, although aspects of the disclosed embodiments are described as being associated with data stored in memory and other tangible computer-readable storage mediums, one skilled in the art will appreciate that these aspects can also be stored on and executed from many types of tangible computer-readable media, such as secondary storage devices, like hard disks, floppy disks, or CD-ROM, or other forms of RAM or ROM. Accordingly, the disclosed embodiments are not limited to the above described examples, but instead is defined by the appended claims in light of their full scope of equivalents.

What is claimed is:

1. A method for registering a merchant for accepting payments using a mobile computing device, the method comprising:
generating a user interface, by a computing device, the user interface including an option for a user to provide registration data from a card containing identification data;
receiving a user selection indicating that the user selected the option to provide the registration data from the card;
generating, by the computing device, a ready signal indicating the user selected the option to provide the registration data from the card;
communicating the ready signal to an input device;
receiving, from the input device, a data signal corresponding to the identification data from the card;
determining, by the computing device, the registration data based on the received data signal;
generating, by the computing device, a second user interface requesting confirmation of the registration data;
receiving, by the computing device, confirmation of the registration data; and
communicating, by the computing device, the registration data to a registration system.

2. The method of claim 1, wherein determining the registration data includes:
determining, by the computing device, account information from the data signal;
determining if the account information corresponds to a financial account; and
requesting a portion of the registration data from an account system.

3. The method of claim 1 wherein the data signal includes an audio signal.

4. The method of claim 3 wherein determining the registration data includes decoding the audio signal.

5. The method of claim 1 wherein the identification data corresponds to magnetically stored track data.

6. The method of claim 1 wherein the ready signal includes instructions configured to cause the input device to read magnetic stripe data encoded according to the ISO/IEC 7813 standard.

7. The method of claim 1 wherein the ready signal includes instructions configured to cause the input device to read magnetic stripe data encoded according to American Association of Motor Vehicle Administrators standards.

8. A mobile device for registering merchants to accept payments using the mobile device, the mobile device comprising:
one or more memory devices storing software instructions; and
one or more processors configured to execute the software instructions to:
generate a user interface including an option for a user to provide registration data from a card containing identification data;
receive a user selection indicating that the user selected the option to provide the registration data from the card;
generate a ready signal indicating the user selected the option to provide the registration data from the card;
communicate the ready signal to an input device;
receive a data signal corresponding to the identification data from the card;
determine the registration data based on the received data signal;
generate a second user interface requesting confirmation of the registration data;
receive confirmation of the registration data; and
communicate the registration data to a registration system.

9. The mobile device of claim 8, wherein determining the registration data includes:
determining account information from the data signal;
determining if the account information corresponds to a financial account; and
requesting a portion of the registration data from an account system.

10. The mobile device of claim 8 wherein the data signal includes an audio signal.

11. The mobile device of claim 10 wherein determining the registration data includes decoding the audio signal.

12. The mobile device of claim 8 wherein the identification data corresponds to magnetically stored track data.

13. The mobile device of claim 8 wherein the ready signal includes instructions configured to cause the input device to read magnetic stripe data encoded according to the ISO/IEC 7813 standard.

14. The mobile device of claim 8 wherein the ready signal includes instructions configured to cause the input device to read magnetic stripe data encoded according to American Association of Motor Vehicle Administrators standards.

15. A non-transitory computer readable medium storing instructions that, when executed by one or more processors, causes the one or more processors to perform operations comprising:
generating a user interface including an option for a user to provide registration data from a card containing identification data;
receiving a user selection indicating that the user selected the option to provide the registration data from the card;
generating a ready signal indicating the user selected the option to provide the registration data from the card;
communicating the ready signal to an input device;
receiving a data signal corresponding to the identification data from the card;
determining the registration data based on the received data signal;
generating a second user interface requesting confirmation of the registration data;
receiving confirmation of the registration data; and
communicating the registration data to a registration system.

16. The non-transitory computer readable medium of claim 15, wherein determining the registration data includes:
determining account information from the data signal;
determining if the account information corresponds to a financial account; and
requesting a portion of the registration data from an account system.

17. The non-transitory computer readable medium of claim 15 wherein the data signal includes an audio signal.

18. The non-transitory computer readable medium of claim 17 wherein determining the registration data includes decoding the audio signal.

19. The non-transitory computer readable medium of claim 15 wherein the identification data corresponds to magnetically stored track data.

20. The non-transitory computer readable medium of claim 15 wherein the ready signal includes instructions configured to cause the input device to read magnetic stripe data encoded according to the ISO/IEC 7813 standard.

21. The non-transitory computer readable medium of claim 15 wherein the ready signal includes instructions configured to cause the input device to read magnetic stripe data encoded according to American Association of Motor Vehicle Administrators standards.
